(19) United States
(12) Patent Application Publication
(10) Pub. No.: US 2026/0270853 A1
(43) Pub. Date: Sep. 10, 2026

(54) METHOD AND APPARATUS FOR ENHANCEMENTS ON NETWORK SLICE SELECTION ASSISTANCE INFORMATION STORAGE MANAGEMENT IN MOBILE COMMUNICATIONS

(71) Applicant: MEDIATEK INC., Hsinchu City (TW)

(72) Inventors: Yu-Hsin LIN, Hsinchu City (TW); Po-Wei CHENG, Hsinchu City (TW); Yung-Chun YANG, Hsinchu City (TW); You-Ru CHEN, Hsinchu City (TW); Yuan-Chieh LIN, Hsinchu City (TW)

(21) Appl. No.: 19/473,072

(22) PCT Filed: Sep. 13, 2024
(86) PCT No.: PCT/CN2024/118702

§ 371 Date: Oct. 6, 2025

Related U.S. Application Data
(60) Provisional application No. 63/587,173, filed on Oct. 2, 2023.

(51) Int. Cl. H04W 48/16; H04W 60/04; H04W 60/06; H04W 88/06

(52) U.S. Cl. CPC H04W 48/16; H04W 60/04; H04W 60/06; H04W 88/06

(57) ABSTRACT

Various solutions for enhancements on network slice selection assistance information (NSSAI) storage management in mobile communications are described. An apparatus may receive a rejected or pending NSSAI from a first network over a first access. The apparatus may perform a registration procedure with a second network over the first access. The apparatus may determine whether it is registered with the first network over a second access. The apparatus may delete the rejected or pending NSSAI in an event that the apparatus is not registered with the first network over the second access.

### CROSS REFERENCE TO RELATED PATENT APPLICATION(S)

The present disclosure is part of a non-provisional application claiming the priority benefit of U.S. Patent Application No. 63/587,173, filed 2 Oct. 2023, the content of which herein being incorporated by reference in its entirety.

### TECHNICAL FIELD

The present disclosure is generally related to mobile communications and, more particularly, to enhancements on network slice selection assistance information (NSSAI) storage management in mobile communications.

### BACKGROUND

Unless otherwise indicated herein, approaches described in this section are not prior art to the claims listed below and are not admitted as prior art by inclusion in this section.

A public land mobile network (PLMN) is a network established and operated by an administration or recognized operating agency (ROA) for the specific purpose of providing land mobile communication services to the public. One PLMN may include multiple radio access networks (RANs) utilizing different radio access technologies (RATs) for accessing mobile services. RAN is part of a mobile communication system, which implements a radio access technology. Conceptually, RAN resides between a mobile device and provides connection with its core network (CN). Depending on the 3^{rd} Generation Partnership Project (3GPP) standards, mobile phones and other mobile devices are varyingly known as user equipment (UE), terminal equipment (TE), mobile stations (MS), or mobile termination (MT), etc. Examples of different RATs include 2^{nd} generation (2G) Global System for Mobile Communications (GSM), 3^{rd}generation (3G) Universal Mobile Telecommunications System (UMTS), 4^{th} generation (4G) Long Term Evolution (LTE), 5th generation (5G) New Radio (NR), and other non-3GPP access RAT including Wireless Fidelity (Wi-Fi).

As compared to PLMN, a non-public network (NPN) is a network for non-public use. An NPN is either a stand-alone NPN (SNPN), i.e., operated by an NPN operator and not relying on network functions provided by a PLMN, or a public network integrated NPN (PNI-NPN), i.e., an NPN deployed with the support of a PLMN. A Credentials Holder (CH) may authenticate and authorize access to an SNPN separate from the CH. The combination of a PLMN ID and Network identifier (NID) identifies an SNPN. A UE may be enabled for SNPN.

In 3GPP Release 18, a UE may be configured with special NSSAI information, such as rejected NSSAI and/or pending NSSAI, and the UE may store the special NSSAI information for subsequent operations, such as network slice selection. For example, if a network slice is in the rejected/pending NSSAI, then the UE should not select this network slice for mobile services. However, in current 3GPP Release 18 standards, the NSSAI storage rules for deleting the rejected/pending NSSAI are unclear in the case of UE entering, selecting, or registering to a new PLMN/SNPN. Moreover, the SNPN handling is missing in the NSSAI storage rules for deleting the rejected/pending NSSAI. As a result, the UE may mistakenly keep or delete the rejected/pending NSSAI, causing incorrect operations. Consequently, the mobile services may be hindered or delayed by the incorrect operations, and this is detrimental to user experience.

Therefore, there is a need to provide proper schemes to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to enhancements on NSSAI storage management in mobile communications. It is believed that the above-described issues would be avoided or otherwise alleviated by implementing one or more of the proposed schemes described herein.

In one aspect, a method may involve an apparatus receiving a rejected or pending NSSAI from a first network over a first access. The method may also involve the apparatus performing a registration procedure with a second network over the first access. The method may also involve the apparatus determining whether it is registered with the first network over a second access. The method may also involve the apparatus deleting the rejected or pending NSSAI in an event that the apparatus is not registered with the first network over the second access.

In one aspect, an apparatus may comprise a transceiver which, during operation, wirelessly communicates with a first network or a second network. The apparatus may also comprise a processor communicatively coupled to the transceiver. The processor, during operation, may perform operations comprising receiving, via the transceiver, a rejected or pending NSSAI from the first network over a first access. The processor may also perform operations comprising performing, via the transceiver, a registration procedure with the second network over the first access. The processor may also perform operations comprising determining whether the apparatus is registered with the first network over a second access. The processor may further perform operations comprising deleting the rejected or pending NSSAI in an event that the apparatus is not registered with the first network over the second access.

It is noteworthy that, although description provided herein may be in the context of certain radio access technologies, networks and network topologies such as LTE, LTE-Advanced, LTE-Advanced Pro, 5G, NR, Internet-of-Things (IOT) and Narrow Band Internet of Things (NB-IoT), Industrial Internet of Things (IIoT), beyond 5G (B5 G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of enhanced NSSAI storage management in accordance with an implementation of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on NSSAI storage management in mobile communications. According to the present disclosure, a number of possible solutions may be implemented separately or jointly. That is, although these possible solutions may be described below separately, two or more of these possible solutions may be implemented in one combination or another.

In the present disclosure, the rejected NSSAI is sent by the network to inform the UE of one or more single-NSSAIs (S-NSSAIs) that were included in the requested NSSAI in the REGISTRATION REQUEST message but were rejected by the network. The rejected NSSAI may include a collection of rejected S-NSSAIs, each of which may include one S-NSSAI and an associated cause value. For example, cause value 0 indicates “S-NSSAI not available in the current PLMN or SNPN”, cause value 1 indicates “S-NSSAI not available in the current registration area”, and cause value 2 indicates “S-NSSAI not available due to the failed or revoked network slice-specific authentication and authorization”, etc. Additionally, the pending NSSAI is sent by the network to inform the UE of one or more S-NSSAIs that are pending as the network slice-specific authentication and authorization procedure is not completed yet. The pending NSSAI may include a collection of pending S-NSSAIs, each of which may include one S-NSSAI and optionally one mapped S-NSSAI.

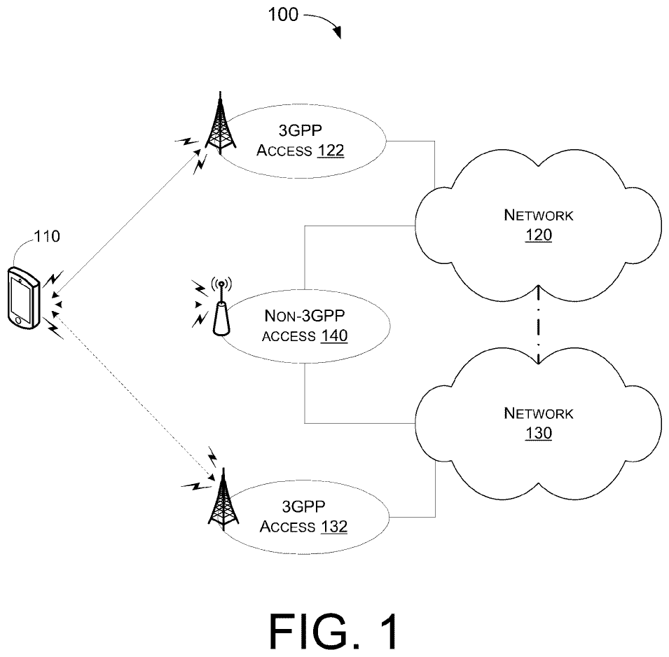

FIG. 1 illustrates an example scenario 100 of a communication environment in which various solutions and schemes in accordance with the present disclosure may be implemented. Scenario 100 involves a UE 110 in wireless communication with either one or both of a wireless network 120 (e.g., a 5G system (5GS)) and a wireless network 130 (e.g., a 5GS or an evolved packet system (EPS)) over a 3GPP access 122/132 and/or a non-3GPP access 140. Each of the 3GPP access 122 and the 3GPP access 132 may be provided by the RAN (e.g., including at least one Next Generation Node-B (gNB) or at least one evolved Node-B (eNB)) of the wireless network 120/130, while the non-3GPP access 140 may be provided by a Wi-Fi access point (AP) connected to the Internet. The wireless networks 120 and 130 may belong to different PLMNs/SNPNs. In one example, interworking between the non-3GPP access 140 and the network 120 (e.g., a 5GS) may be supported through a Y2 interface connecting the non-3GPP access 140 to the core network node, e.g., a non-3GPP interworking function (N3IWF). In another example, interworking between the non-3GPP access 140 and the network 130 (e.g., an EPS) may be supported through an SWn interface connecting the non-3GPP access 140 to the core network node, e.g., an evolved packet data gateway (ePDG). In one example, interworking between the network 120 (e.g., a 5GS) and the network 130 (e.g., an EPS) may be supported through an N26 interface and/or an S5 interface, where the N26 interface connects the core network nodes, e.g., 4G's mobility management entity (MME) and 5G's access and mobility management function (AMF), to allow them to coordinate the UE's mobility management, and the S5 interface connects the core network nodes, e.g., 4G's serving gateway (SGW) and 5G's packet gateway (PGW), to coordinate the UE's data connectivity. Although not shown, each of the wireless networks 120 and 130 may further connect to an internet protocol (IP) multimedia subsystem (IMS) which is responsible for delivering IP multimedia services, including voice call services (e.g., voice over IP (VoIP), voice over LTE (VoLTE), and voice over NR (VoNR)) and emergency services (e.g., circuit-switched (CS) emergency call, emergency bearer services, etc.). In such communication environment, the UE 110 may implement various schemes pertaining to enhancements on NSSAI storage management in mobile communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In current 3GPP Release 18 standards, the NSSAI storage rules for deleting the rejected/pending NSSAI use the term “current PLMN/SNPN” following the case of UE entering, selecting, or registering to a new PLMN/SNPN. Specifically, the NSSAI storage rules define that when the UE successfully registers with a new PLMN/SNPN, or enters state 5GMM-DEREGISTERED following an unsuccessful registration with a new PLMN, or performs an inter-system change from N1 mode to S1 mode and the UE successfully completes tracking area update procedure, the rejected NSSAI for the current PLMN/SNPN should be deleted if the UE is not registered with the current PLMN/SNPN over another access. In addition, the NSSAI storage rules define that when the UE successfully registers with a new PLMN not in the list of equivalent PLMNs or a new SNPN, or enters state 5GMM-DEREGISTERED following an unsuccessful registration with a new PLMN or SNPN, or successfully initiates an attach or tracking area update procedure in S1 mode and the UE is operating in single-registration mode, the pending NSSAI for the current PLMN and its equivalent PLMN(s) in the registration area or the current SNPN should be deleted if the UE is not registered with the current PLMN/SNPN over another access. However, once a new PLMN/SNPN is selected/entered/registered, this new PLMN/SNPN becomes the current PLMN/SNPN, and thus, using “new PLMN/SNPN” and “current PLMN/SNPN” in the same paragraph is misleading. Furthermore, the SNPN handling is missing in some cases of the NSSAI storage rules. As a result, the UE may mistakenly keep or delete the rejected/pending NSSAI, causing incorrect operations. Consequently, the mobile services may be hindered or delayed by the incorrect operations, and this is detrimental to user experience.

In view of the above, the present disclosure proposes a number of schemes pertaining to enhancements on NSSAI storage management in mobile communications. According to the schemes of the present disclosure, the NSSAI storage rules for deleting the rejected/pending NSSAI are enhanced by replacing “current PLMN/SNPN” with “the PLMN/SNPN, which provided the rejected/pending NSSAI(, and its equivalent PLMN/SNPN)”, and adding the missing SNPN handling. More specifically, after a UE receives a rejected/pending NSSAI from the first network (e.g., a PLMN or an SNPN) over one access (e.g., one of 3GPP access and non-3GPP access), the rejected/pending NSSAI is stored in a non-volatile memory in the mobile equipment (ME) of the UE (e.g., the ME and the universal subscriber identity module (USIM) together form the UE). Then, the UE may delete the rejected/pending NSSAI when it enters/selects/registers to a new network (e.g., the second network such as a PLMN or an SNPN) over the same access and it is not registered with the first network (i.e., the network which provided the rejected/pending NSSAI) or its equivalent network over another access (e.g., another one of 3GPP access and non-3GPP access). Accordingly, by applying the schemes of the present disclosure, the rejected/pending NSSAI may be correctly managed to ensure normal operations in mobile communications.

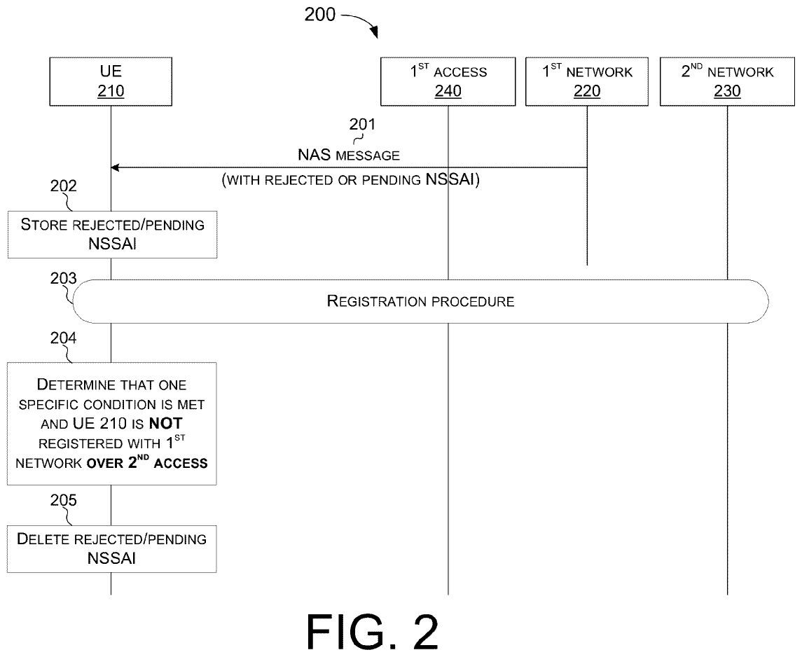

FIG. 2 illustrates an example scenario 200 of enhanced NSSAI storage management in accordance with an implementation of the present disclosure. In step 201, the UE 210 receives a non-access stratum (NAS) message including a rejected/pending NSSAI from the first network 220 over the first access 240 (e.g., one of 3GPP access and non-3GPP access). In one example, the NAS message including a rejected NSSAI may be a REGISTRATION ACCEPT message, a REGISTRATION REJECT message, a DEREGISTRATION REQUEST message, or a CONFIGURATION UPDATE COMMAND message. In another example, the NAS message including a pending NSSAI may be a REGISTRATION ACCEPT message. In step 202, the UE 210 stores the rejected/pending NSSAI in a non-volatile memory in the ME. In step 203, the UE 210 performs a registration procedure with the second network 230 over the first access. In one example, the registration procedure may involve a registration procedure in N1 mode, or an inter-system change from N1 mode to S1 mode, or an attach or tracking area update procedure in S1 mode.

Subsequently, in step 204, the UE 210 determines that one specific condition is met and the UE 210 is not registered with the first network 220 over the second access (e.g., another one of 3GPP access and non-3GPP access). In one example, if a rejected NSSAI is received in step 201, the specific condition may include one of the following: (i) the UE 210 successfully registers with a new PLMN/SNPN; (ii) the UE 210 enters state 5GMM-DEREGISTERED following an unsuccessful registration with a new PLMN/SNPN; and (iii) the UE 210 performs an inter-system change from N1 mode to S1 mode and the UE 210 successfully completes a tracking area update procedure. In another example, if a pending NSSAI is received in step 201, the specific condition may include one of the following: (i) the UE 210 successfully registers with a new PLMN not in the list of equivalent PLMNs or a new SNPN; (ii) the UE 210 enters state 5GMM-DEREGISTERED following an unsuccessful registration with a new PLMN (not in the list of equivalent PLMNs) or a new SNPN (not in the list of equivalent SNPNs); and (iii) the UE 210 successfully initiates an attach or tracking area update procedure in S1 mode and the UE 210 is operating in single-registration mode. In step 205, the UE 210 deletes the rejected/pending NSSAI for the first network 220 (and its equivalent networks (e.g., PLMNs/SNPNs)).

### Illustrative Implementations

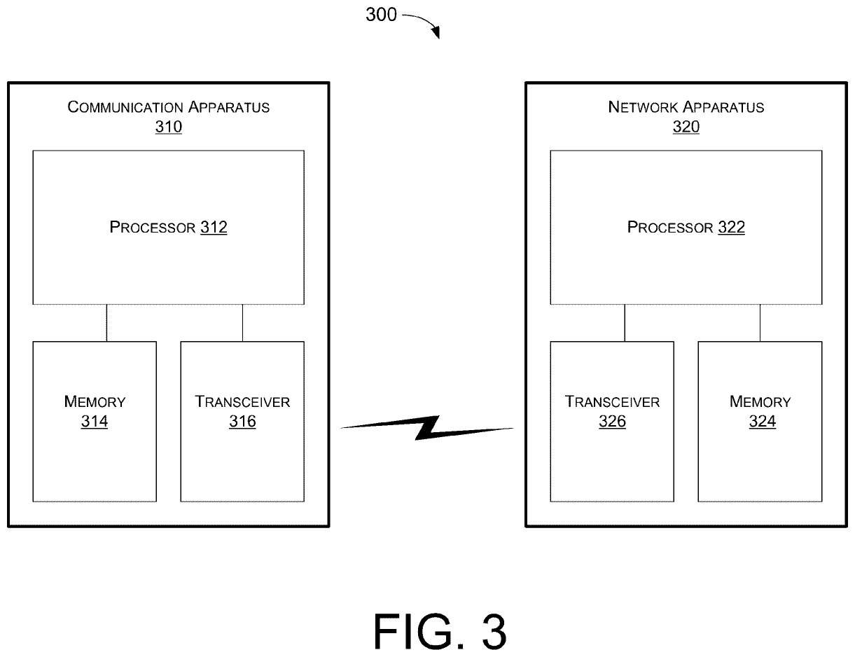

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to enhancements on NSSAI storage management in mobile communications, including scenarios/schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 310 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a non-3GPP access node (e.g., a Wi-Fi AP) or a 3GPP access node (e.g., an eNB, a gNB, a TRP, a small cell, a router or a gateway) of a wireless network (e.g., a 4G/5G/B5G/6G network), connecting communication apparatus 310 to the core network (e.g., an EPC or a 5GC) of the wireless network. For instance, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks, including enhancements on NSSAI storage management in mobile communications, in a UE (e.g., as represented by communication apparatus 310) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of UEs and/or wireless networks of different RATs, e.g., 2G GSM, 3G UMTS, 4G LTE, 5G NR, and/or 6G. In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, network apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, communication apparatus 310 may further include a memory 314 coupled to processor 312 and capable of being accessed by processor 312 and storing data (e.g., the rejected/pending NSSAI) therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 310 and network apparatus 320 may be a communication entity capable of communicating with each other using various proposed schemes in accordance with the present disclosure. For illustrative purposes and without limitation, a description of capabilities of communication apparatus 310, as a UE, is provided below with process 400.

### Illustrative Processes

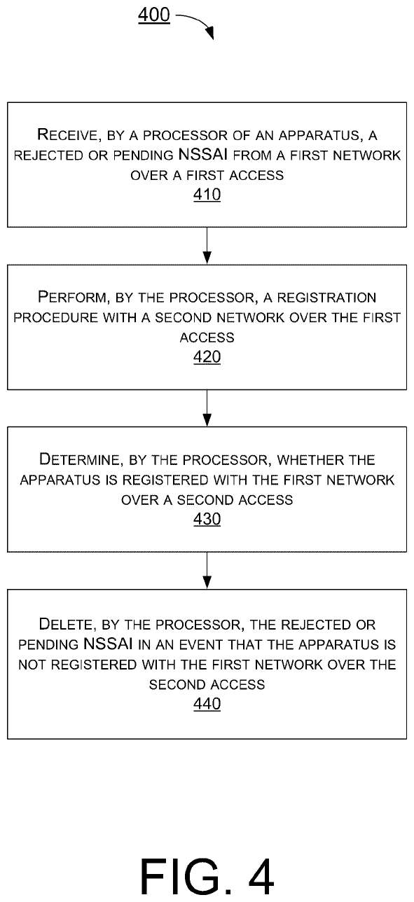

FIG. 4 illustrates an example process 400 in accordance with an implementation of the present disclosure. Process 400 may be an example implementation of above scenarios/schemes, whether partially or completely, with respect to enhancements on NSSAI storage management in mobile communications. Process 400 may represent an aspect of implementation of features of communication apparatus 310. Process 400 may include one or more operations, actions, or functions as illustrated by one or more of blocks 410 to 440. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by or in communication apparatus 310 or any suitable UE or machine type devices. Solely for illustrative purposes and without limitation, process 400 is described below in the context of communication apparatus 310 as a UE. Process 400 may begin at block 410.

At 410, process 400 may involve processor 312 of communication apparatus 310 receiving, via transceiver 316, a rejected or pending NSSAI from a first network over a first access. Process 400 may proceed from 410 to 420.

At 420, process 400 may involve processor 312 performing, via transceiver 316, a registration procedure with a second network over the first access. Process 400 may proceed from 420 to 430.

At 430, process 400 may involve processor 312 determining whether communication apparatus 310 is registered with the first network over a second access. Process 400 may proceed from 430 to 440.

At 440, process 400 may involve processor 312 deleting the rejected or pending NSSAI in an event that communication apparatus 310 is not registered with the first network over the second access.

In some implementations, process 400 may further involve processor 312 determining not to delete the rejected or pending NSSAI in an event that communication apparatus 310 is registered with the first network over the second access.

In some implementations, process 400 may further involve processor 312 determining whether communication apparatus 310 is registered with an equivalent network of the first network over the second access, and deleting the rejected or pending NSSAI in an event that communication apparatus 310 is not registered with the equivalent network over the second access.

In some implementations, communication apparatus 310 is successfully registered with the second network after the registration procedure in an event that the rejected NSSAI is received.

In some implementations, process 400 may further involve processor 312 entering a deregistered state (e.g., 5GMM-DEREGISTERED state) after the registration procedure is unsuccessful in an event that the rejected NSSAI is received.

In some implementations, the registration procedure may include an inter-system change from an advanced system to a legacy system (i.e., from N1 mode to S1 mode) and communication apparatus 310 successfully completes a tracking area update procedure, in an event that the rejected NSSAI is received.

In some implementations, communication apparatus 310 is successfully registered with the second network that is not in a list of equivalent networks after the registration procedure in an event that the pending NSSAI is received.

In some implementations, process 400 may further involve processor 312 entering a deregistered state (e.g., 5GMM-DEREGISTERED state) after the registration procedure with the second network that is not in a list of equivalent networks is unsuccessful in an event that the pending NSSAI is received.

In some implementations, the registration procedure may include an attach or tracking area update procedure and communication apparatus 310 is operating in a single-registration mode, in an event that the pending NSSAI is received.

In some implementations, each of the first network and the second network may include a PLMN or an SNPN.

In some implementations, the first access may include one of a 3GPP access and a non-3GPP access, and the second access may include another one of the 3GPP access and the non-3GPP access.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a rejected or pending network slice selection assistance information (NSSAI) from a first network over a first access;
performing, by the processor, a registration procedure with a second network over the first access;
determining, by the processor, whether the apparatus is registered with the first network over a second access; and
deleting, by the processor, the rejected or pending NSSAI in an event that the apparatus is not registered with the first network over the second access.

2. The method of claim 1, further comprising:
determining, by the processor, not to delete the rejected or pending NSSAI in an event that the apparatus is registered with the first network over the second access.

3. The method of claim 1, further comprising:
determining, by the processor, whether the apparatus is registered with an equivalent network of the first network over the second access; and
deleting, by the processor, the rejected or pending NSSAI in an event that the apparatus is not registered with the equivalent network over the second access.

4. The method of claim 1, wherein the apparatus is successfully registered with the second network after the registration procedure in an event that the rejected NSSAI is received.

5. The method of claim 1, further comprising:
entering, by the processor, a deregistered state after the registration procedure is unsuccessful in an event that the rejected NSSAI is received.

6. The method of claim 1, wherein the registration procedure comprises an inter-system change from an advanced system to a legacy system and the apparatus successfully completes a tracking area update procedure, in an event that the rejected NSSAI is received.

7. The method of claim 1, wherein the apparatus is successfully registered with the second network that is not in a list of equivalent networks after the registration procedure in an event that the pending NSSAI is received.

8. The method of claim 1, further comprising:
entering, by the processor, a deregistered state after the registration procedure with the second network that is not in a list of equivalent networks is unsuccessful in an event that the pending NSSAI is received.

9. The method of claim 1, wherein the registration procedure comprises an attach or tracking area update procedure and the apparatus is operating in a single-registration mode, in an event that the pending NSSAI is received.

10. The method of claim 1, wherein each of the first network and the second network comprises a public land mobile network (PLMN) or a standalone non-public network (SNPN), the first access comprises one of a 3^{rd} generation partnership project (3GPP) access and a non-3GPP access, and the second access comprises another one of the 3GPP access and the non-3GPP access.

11. An apparatus, comprising:
a transceiver which, during operation, wirelessly communicates with a first network or a second network; and
a processor communicatively coupled to the transceiver such that, during operation, the processor performs operations comprising:
receiving, via the transceiver, a rejected or pending network slice selection assistance information (NSSAI) from the first network over a first access;
performing, via the transceiver, a registration procedure with the second network over the first access;
determining whether the apparatus is registered with the first network over a second access; and
deleting the rejected or pending NSSAI in an event that the apparatus is not registered with the first network over the second access.

12. The apparatus of claim 11, wherein, during operation, the processor further performs operations comprising:
determining not to delete the rejected or pending NSSAI in an event that the apparatus is registered with the first network over the second access.

13. The apparatus of claim 11, wherein, during operation, the processor further performs operations comprising:
determining whether the apparatus is registered with an equivalent network of the first network over the second access; and
deleting the rejected or pending NSSAI in an event that the apparatus is not registered with the equivalent network over the second access.

14. The apparatus of claim 11, wherein the apparatus is successfully registered with the second network after the registration procedure in an event that the rejected NSSAI is received.

15. The apparatus of claim 11, wherein, during operation, the processor further performs operations comprising:
entering a deregistered state after the registration procedure is unsuccessful in an event that the rejected NSSAI is received.

16. The apparatus of claim 11, wherein the registration procedure comprises an inter-system change from an advanced system to a legacy system and the apparatus successfully completes a tracking area update procedure, in an event that the rejected NSSAI is received.

17. The apparatus of claim 11, wherein the apparatus is successfully registered with the second network that is not in a list of equivalent networks after the registration procedure in an event that the pending NSSAI is received.

18. The apparatus of claim 11, wherein, during operation, the processor further performs operations comprising:
entering a deregistered state after the registration procedure with the second network that is not in a list of equivalent networks is unsuccessful in an event that the pending NSSAI is received.

19. The apparatus of claim 11, wherein the registration procedure comprises an attach or tracking area update procedure and the apparatus is operating in a single-registration mode, in an event that the pending NSSAI is received.

20. The apparatus of claim 11, wherein each of the first network and the second network comprises a public land mobile network (PLMN) or a standalone non-public network (SNPN), the first access comprises one of a 3^{rd} generation partnership project (3GPP) access and a non-3GPP access, and the second access comprises another one of the 3GPP access and the non-3GPP access.
